(19) United States
(12) Patent Application Publication
(10) Pub. No.: US 2011/0259131 A1
(43) Pub. Date: Oct. 27, 2011

(54) LIGHT MODULE ADJUSTMENT APPARATUS AND METHOD

(75) Inventor: Dirk Du Mont, Erwitte (DE)

(73) Assignee: HELLA KGAA HUECK & CO., Lippstadt (DE)

(21) Appl. No.: 13/093,500

(22) Filed: Apr. 25, 2011

(30) Foreign Application Priority Data
Apr. 27, 2010 (EP) 10161175.4

(51) Int. Cl. F16H 25/08

(52) U.S. Cl. 74/25

(57) ABSTRACT

The present invention relates to an apparatus for adjusting a light module along a horizontal or a vertical axis, comprising an actuator and a linear control element which can be moved in an adjustment direction and is driven by said actuator to operate an adjustment mechanism, wherein an articulated joint connects said mechanism to a carrier of the light module and wherein an articulated joint connects a free end of the linear control element to the adjustment mechanism such that said linear control element can pivot around a first axis of rotation perpendicular to the adjustment direction to make up a first pivot joint, wherein the adjustment mechanism provides a control element (2) as an integrated whole and wherein the control element (2) and/or the carrier (3) are designed such that a second pivot joint allows the control element (2) to pivot around a second axis of rotation (D2) perpendicular to the first axis of rotation (D1).

The present invention relates to an apparatus for adjusting a light module along a horizontal or vertical axis, using an actuator connected to a linear control element which can be moved in an adjustment direction and is driven by said actuator to operate an adjustment mechanism through an articulated joint that connects said mechanism to a carrier of the light module, wherein an articulated joint connects a free end of the linear control element to the adjustment mechanism such that said linear control element can pivot around a first axis of rotation perpendicular to the adjustment direction to make up a first pivot joint.

EP 2 112 021 A1 discloses an apparatus for adjusting a light module along a horizontal or vertical axis, using an actuator and an adjustment mechanism to operate a carrier of the light module such that the light module may pivot around a horizontal axis in order to dynamically adjust said light module with reference to the current road situation. In this design, the apparatus resides in a top corner of and, looking in the direction of light emission, behind the carrier. A ball joint links the adjustment mechanism to the carrier such that a translational movement of a linear control element fixed to the actuator is transformed into a pivoting movement of the light module. The adjustment mechanism comprises a first control element with a threaded shaft and a spherical head linked to a ball joint element of the carrier. The adjustment mechanism further comprises a second control element that is thread-mounted to the first control element and, on a side facing the actuator, comprises a socket-shaped seat for a head of the linear control element located at a free end of said linear control element. In order to prevent unwanted radial forces affecting the actuator in horizontal direction, the socket-shaped seat opens out in horizontal direction such that the carrier may perform a compensating movement in horizontal direction and in relation to the actuator, for example if component tolerances force the carrier and the actuator to change their position in relation to one another. A disadvantage of the apparatus of the prior art is that the adjustment mechanism requires a plurality of control elements in order to impose an adjusting force that will cause the light module to pivot. Moreover, only a limited compensation, that is to say in horizontal direction, is available to prevent radial forces of the carrier to go into the actuator.

The task of the present invention therefore is to further develop an apparatus for adjusting a light module along a horizontal or a vertical axis such that a simple and room-saving interlock between an actuator and carrier fixed to the light module is provided while radial forces are prevented.

In order to accomplish this task, the invention together with the characterizing clause of patent claim 1 is characterized in that the adjustment mechanism is a control element designed as an integral whole and in that the control element and/or the carrier is designed such that a second pivot joint allows the control element to pivot around a second axis of ration perpendicular to the first axis of rotation.

The invention particularly benefits from the connection between an actuator and a carrier of the light module generating no radial forces whatsoever and from the design being compact. The actuator links to the carrier by just a single control element such that the actuator links to the control element and may pivot with it around a first axis of rotation, and the control element further links to the carrier and may pivot with it around a second axis of rotation perpendicular to the first axis of rotation. Thus, a single control element couples a linear control element of the actuator to the carrier.

In a further development of the invention, a pivot joint seat is located in an axial section of the control element such that a free end of the linear control element may be seated in said pivot joint seat to make up a first pivot joint. This provides an advantageous means of eliminating radial forces by a rotation around the first axis of rotation. Since the pivot joint seat opens out in the direction of the first axis of rotation, the radial forces otherwise affecting the linear control element during the pivot action can be eliminated.

In a further development of the invention, the second articulated joint is a pivot joint comprising an arched face that interacts with a straight face. The control element preferably has an arched face that contacts a straight face of a bearing lug that forms an integral whole together with the carrier. The arched face is perpendicular to the second axis of rotation such that radial forces between the control element and the carrier are eliminated by pivoting the control element around the second axis of rotation.

In a further development of the invention, the control element resides in a bearing lug of the carrier and is forced to move in the adjustment direction, wherein said control element is jammed between an articulated element of the carrier and a head of the linear control element. Thus, the design of the apparatus is simple and short and comprises a few articulated elements only which allow the light module to pivot while eliminating all radial forces on the bearing of the actuator.

In a further development of the invention, the apparatus comprises a second control element for manually adjusting the light module around a horizontal axis, wherein said second control element is thread-mounted to the carrier. The threaded mount resides in a plate of the carrier located on a side opposite the bearing lugs. Thus, basic adjustment of the light module around a horizontal axis may be performed manually by means of a tool.

For other advantages of the invention refer to the other dependent claims.

The text below explains an embodiment of the invention with reference to the drawings.

The following is shown:

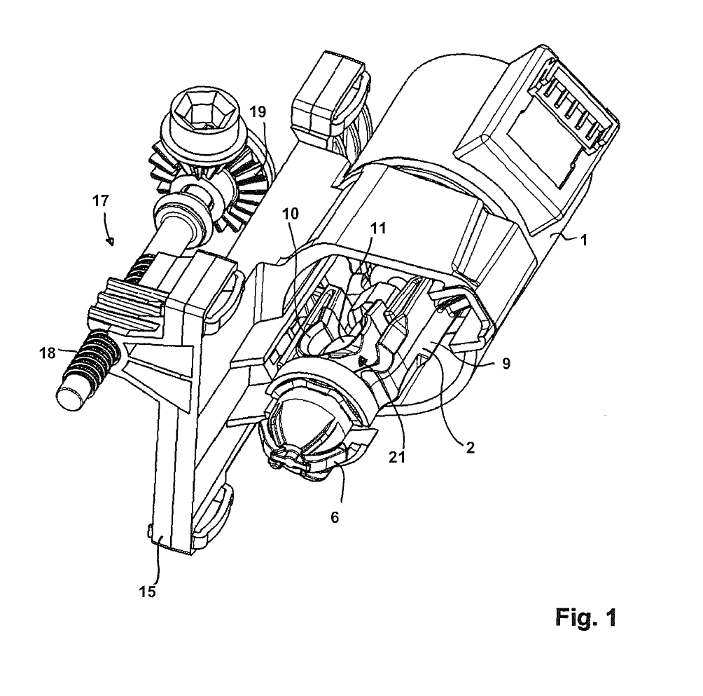

FIG. 1 a perspective front view of an inventive apparatus,

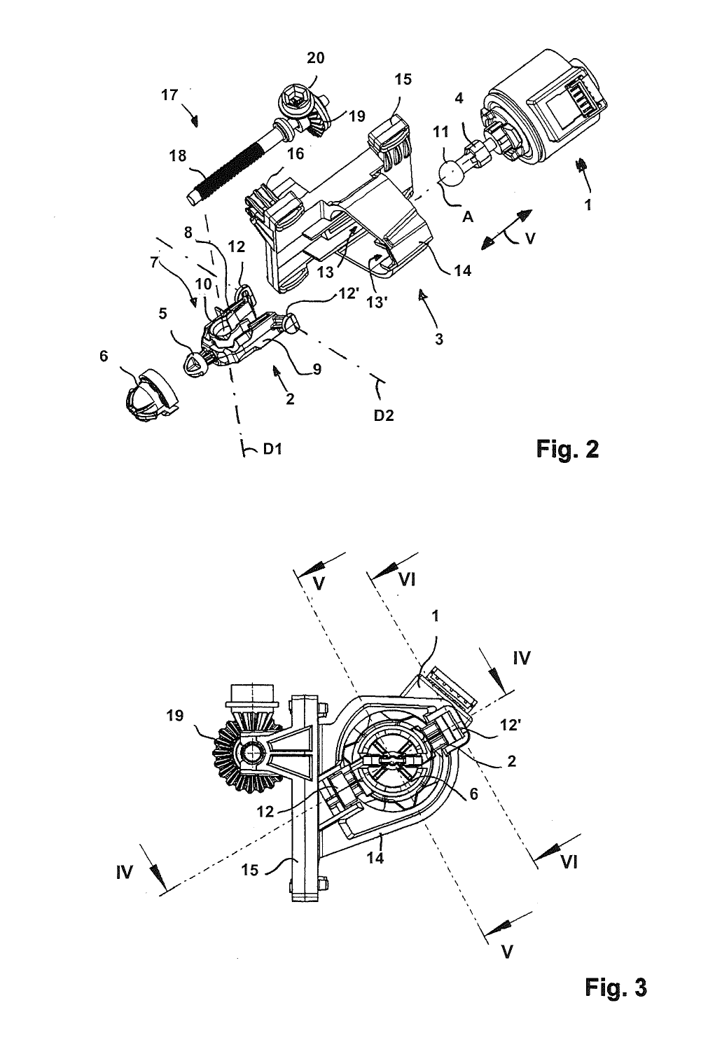

FIG. 2 an exploded view of the inventive apparatus,

FIG. 3 a front view of the inventive apparatus,

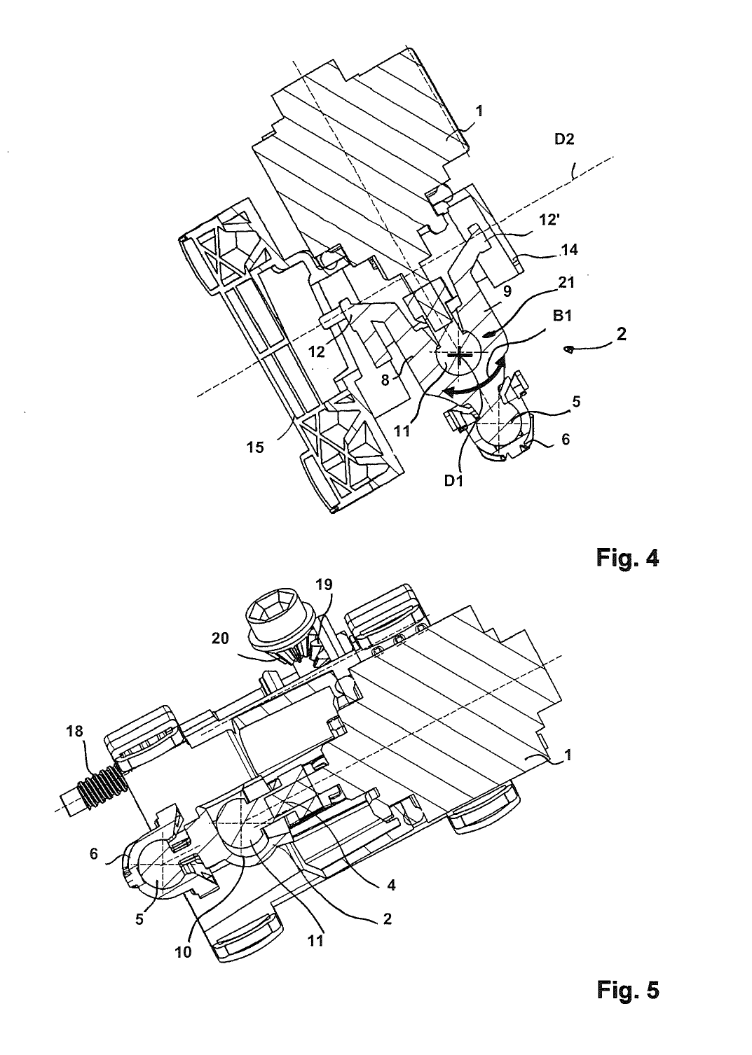

FIG. 4 a longitudinal section of the apparatus along intersecting line IV-IV of FIG. 3,

FIG. 5 a longitudinal section of the apparatus along intersecting line V-V of FIG. 3, and

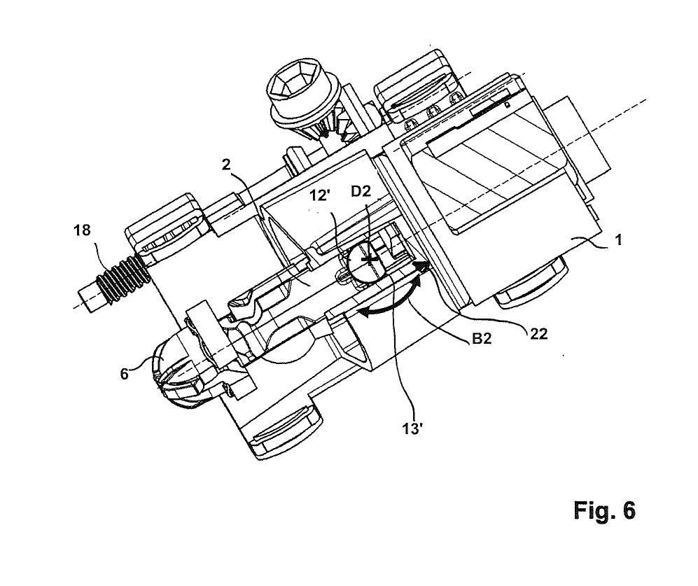

FIG. 6 a longitudinal section of the apparatus along intersecting line VI-VI of FIG. 3

An inventive apparatus for adjusting a light module around a horizontal or vertical axis essentially comprises an actuator 1, an adjustment mechanism 2 linked to said actuator 1, and a carrier 3 of the light module linked to said adjustment mechanism 2. The light module may be a headlamp of a motor vehicle, for example, comprising a light source and a reflector allocated to said light source such that the light source and the reflector generate a low beam distribution and/or a high beam distribution. Instead, the light module may also comprise one or a plurality of LED elements serving as a light source. The light module is linked to a carrier not shown in the Figures. The carrier 3 is essentially intended to seat the actuator 1 and the adjustment mechanism 2. The carrier 3 may be mounted on the housing of a lighting apparatus not shown in the Figures, said lighting apparatus possibly being able to house further light modules.

The actuator 1 is an electrical drive, for example a stepper motor, comprising a linear control element 4 which may be moved in an adjustment direction V (axial direction). The purpose of the actuator 1 is to dynamically adjust the light module around a horizontal axis such that the light module is directed at the road in front of the vehicle both in a previously defined manner and with reference to the current driving situation. The light range of the light module may thus be adjusted.

The adjustment mechanism is a control element 2 designed as an integral whole and comprising a plurality of joint connections. On a side facing away from the actuator 1, the control element 2 comprises a head 5 resting in a ball socket 6 fixed to the carrier and intended to provide a ball joint. This allows the linear movement performed by the control element 2 in adjustment direction V to be transformed into a pivoting movement of the light module.

The head 5 of the control element 2 is located at an apex 7 of the control element 2 such that a first leg 8 and a second leg 9 essentially parallel to said first leg 8 protrude from said apex 7 towards the actuator 1. The two legs 8, 9 are essentially parallel to an adjustment axis A of the linear control element 4 or the control element 2.

At the apex 7 of the control element 2, a section of the first leg 8 and a section of the second leg 9 interconnect to make up a pivot joint seat 10 that a head-shaped free end 11 of the linear control element 4 is seated in. The pivot joint seat 10 has a bow-shaped horizontal section such that the linear control element 4 may pivot around a first perpendicular axis of rotation D1 with reference to the control element 2, see direction of movement B1 in FIG. 4.

The pivot joint seat 10 opens out towards the first axis of rotation D1 such that the head-shaped end 11 of the linear control element 4 is allowed to perform a compensating movement towards the first axis of rotation D1 when the light module is pivoting.

Arched faces 12, 12′ down a vertical plane are provided at the free ends of the first leg 8 and the second leg 9 of the control element 2 such that said arched faces 12, 12′ contact a straight face 13, 13′ of a bearing lug 14 of the carrier 3. The arched faces 12, 12′ preferably have circular sections and extend along an obtuse or reflex angle. A mid-point of the opposing arched face 12, 12′ defines a second axis of rotation D2 which is perpendicular to the first axis of rotation D1. The second axis of rotation D2 preferably extends in horizontal direction such that a second pivot joint 22 is made that allows the actuator 1 to turn around the second axis of rotation D2 in order to compensate its position with reference to the carrier 3, see direction of movement B2 in FIG. 6.

The arched face 12, 12′ is perpendicular to the second axis of rotation D2. The straight face 13, 13′ is perpendicular to the second axis of rotation D2 and also extends in the adjustment direction V.

The bearing lug 14 of the carrier 3 has a sleeve-like shape and has further bearing faces in excess of the straight bearing face 13, 13′ such that the control element 2 may move in the adjustment direction V. The bearing lug 14 makes up an integral whole with a vertical panel 15 of the carrier 3, one side of said vertical panel 15 opposite of said bearing lug 14 making up a preferably integral whole with an adjustment sleeve 16 which has an inside thread that a second control element 17 is thread-mounted on. The second control element 17 has a threaded shaft 18 thread-mounted on the adjustment sleeve 16 as well as a gear wheel 19 perpendicular to said threaded shaft 18 and interacting with a pinion gear 20 as a pair of beveled wheels. The pinion gear 20 has an opening for a tool such that the second control element 17 may be turned around an axis parallel to the adjustment axis A in order to provide a static adjustment of the light module around a horizontal axis D2. To this end, the second control element 17 is mounted on the housing of the lighting apparatus not shown in the Figures such that said second control element 17 is stopped from moving in axial direction. Fixing material not shown in the Figures also mounts the actuator 1 to the housing of the lighting apparatus and stops it from moving in axial direction.

The first control element 2 and the second control element 17 and the bearing lug 14 as well as the carrier 3 are preferably made of a plastic material.

What is claimed is:

1. An apparatus for adjusting a light module along a horizontal or a vertical axis, comprising:
an actuator and a linear control element which can be moved in an adjustment direction and is driven by said actuator to operate an adjustment mechanism;
an articulated joint connects said mechanism to a carrier of the light module and wherein an articulated joint connects a free end of the linear control element to the adjustment mechanism such that said linear control element can pivot around a first axis of rotation perpendicular to the adjustment direction to make up a first pivot joint;
the adjustment mechanism provides a control element as an integrated whole; and
a second pivot joint in one of said control element or said carrier allows the control element to pivot around a second axis of rotation substantially perpendicular to the first axis of rotation.

2. The apparatus of claim 1, characterized in that a pivot joint seat is located in an axial section of the control element for seating a free end of the linear control element therein to make a first pivot joint, wherein the pivot joint seat opens out towards the first axis of rotation.

3. The apparatus of claim 1, characterized in that the second pivot joint is located at a distance to the adjustment axis of the linear control element and in that a second pivot joint is made by an arched face perpendicular to the second axis of rotation and contacting a straight face extending in a direction of adjustment.

4. The apparatus of claim 1, characterized in that a straight face is a bearing face extending in adjustment direction inside a bearing lug of the carrier, wherein the control element resides in the bearing lug and is forced to move in adjustment direction.

5. The apparatus of claim 1, characterized in that the control element is symmetrical to a long center plane providing a seat for one of the first axis of rotation or the second axis of rotation and having a first leg and a second leg such that said legs meet at an apex, wherein the apex houses the pivot joint seat of the linear control element and a head holding the control element in a ball socket of a carrier holding the light module, and wherein a first arched face is allocated to the first leg and a second arched face is allocated to the second leg.

6. The apparatus of claim 1, characterized in that a first arched face and a second arched face are located at a free end of a first leg and a second leg respectively.

7. The apparatus of claim 1, characterized in that a head of the control element located in an apex is connected to an articulated element of the carrier such that they make up a ball joint.

8. The apparatus of claim 1, characterized in that the actuator is an electrical drive in a stationary arrangement.

9. The apparatus of claim 1, characterized in that the first axis of rotation extends in a substantially vertical direction and the second axis of rotation extends in a substantially horizontal direction.

10. The apparatus of claim 1, characterized in that a second control element is thread-mounted to the carrier such that the light module may be manually adjusted along a horizontal axis.
